(19) United States
(12) Patent Application Publication
(10) Pub. No.: US 2001/0007389 A1
(43) Pub. Date: Jul. 12, 2001

(54) Wheelchair hand rim

(76) Inventor: Carol Frauwirth, Massapequa Park, NY (US)

Correspondence Address: Myron Amer, P.C., 114 Old Country Road, Mineola, NY, 11501, US

(21) Appl. No.: 09/798,050

(22) Filed: Mar. 5, 2001

Related U.S. Application Data
(63) Continuation of application No. 08/634,341, filed on Apr. 18, 1996.

(51) Int. Cl. B62J 1/00

(52) U.S. Cl. 280/304.1

(57) ABSTRACT

A covering over a grasped metal wheel-rotating hand rim of a wheelchair which keeps the user's typical indoor 90 degrees F. hand temperature at or near this temperature to provide a comfortable warm-to-the-touch feeling and, conversely, obviating a cold-to-the-touch feeling characteristic of an uncovered hand rim.

The present invention relates generally to improvements for a hand rim of a wheelchair wheel, the improvements more particularly obviating the cold-to-the-touch feeling experienced by contact with the steel construction material of the hand rim.

### EXAMPLES OF THE PRIOR ART

As known, the tire rim of the wheelchair wheel is able to be constructed of a hard plastic to adequately serve the purposes intended, but the hand rim attached to the wheel and used to propel the wheel in rotation requires a stronger material of construction, and such material of choice is typically steel, even though it is often reported as being uncomfortable to touch, i.e. cold-to-the-touch.

Solutions in the analogous vehicle steering wheel prior art, as exemplified by U.S. Pat. No. 5,042,318 issued to Eric C. Franz for “Steering Wheel Cover with a Knurly Configured Gripping Surface” on Aug. 27, 1991, U.S. Pat. No. 4,441,382 issued to Laura K. Snooks for “Steering Wheel Cover” on Apr. 10, 1984, and U.S. Pat. No. 5,287,767 issued to Jacob Engelstein for “Vehicle Steering Wheel Cover” on Feb. 22, 1994, to mention but a few, focus on solutions related to ambient conditions of use, namely an uncomfortable steering wheel that is too cold because parked in frigid climatic conditions or too hot because of the impingement of sunshine through the windshield. The solution is a prescribed cover for the steering wheel, such as neoprene in U.S Pat. No. 5,042,318, but the obvious shortcoming is that the cover, like the steering wheel, being subject to the same ambient conditions also suffers from becoming too cold or too hot, as the case may be, and correspondingly also uncomfortable to touch.

Underlying the present invention is the recognition that the circumstances of use of a wheelchair wheel hand rim is not the cause of the problem, being typically 72 degrees F., but rather the failure to maintain the hand temperature of the user, which typically is 90 degrees F. or just slightly below normal body temperature of 98.6 degrees F.

Broadly, it is an object of the present invention to provide a comfortable-to-the-touch covered wheelchair wheel hand rim overcoming the foregoing and other shortcomings of the prior art.

More particularly, it is an object to obviate the often complained of cold-to-the-touch feeling even in a comfortable indoor environment of 72 degrees F. using a hand rim cover effective to control the hand temperature of the user, all as will be better understood from the description which follows.

The description of the invention which follows, together with the accompanying drawings should not be construed as limiting the invention to the example shown and described, because those skilled in the art to which this invention appertains will be able to devise other forms thereof within the ambit of the appended claims.

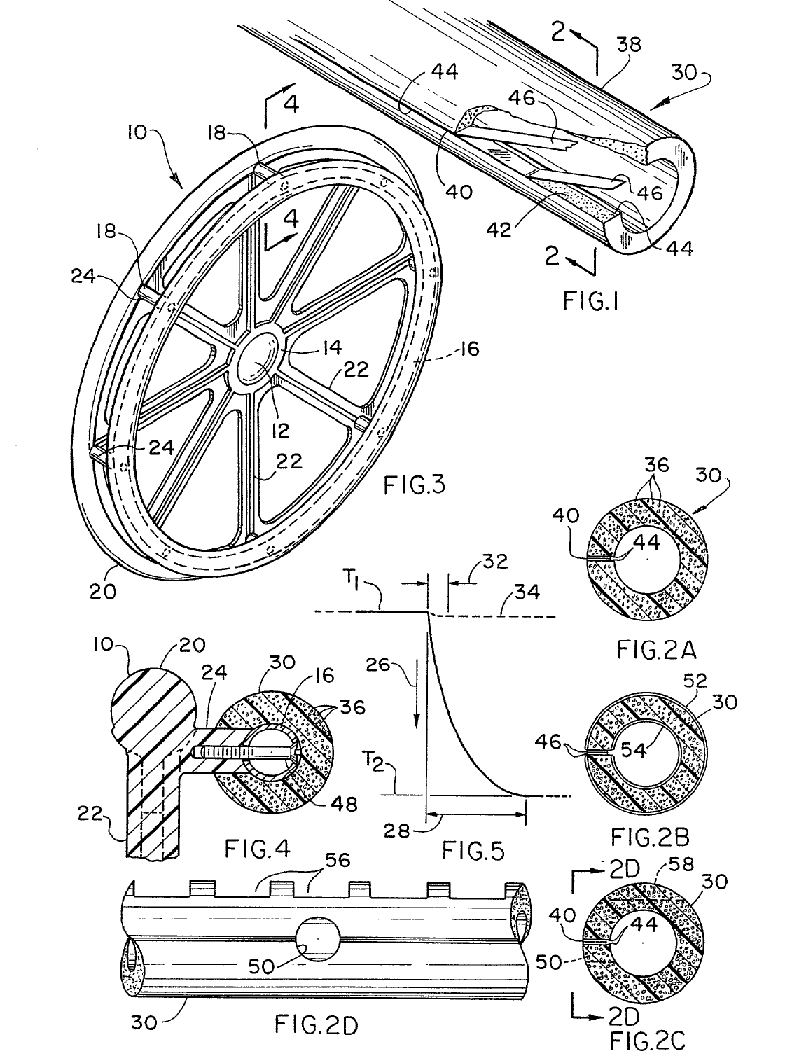

FIG. 1 is a partial perspective view of a length portion of the within inventive wheelchair hand rim covering providing a feeling to the user's finger grasp that is warm-to-the-touch;

FIGS. 2A, 2B and 2C are cross sectional views, taken along line 2-2 of FIG. 1, of respective first, second and third embodiments of the wheelchair hand rim covering of FIG. 1;

FIG. 3 is a perspective view of the wheelchair wheel to which there is attached a hand rim and covering in assembled relation;

FIG. 4 is a cross sectional view, taken along line 4-4 of FIG. 3; and

FIG. 5 is a diagrammatic illustration of principals of heat transfer providing the warm-to-the-touch utility of the FIG. 1 wheelchair hand rim covering.

To urge a wheelchair in motion, use is made of cooperating wheels, as exemplified by wheel 10, appropriated journalled for rotation on a wheelchair axle 12 disposed in opposite hubs 14, the rotative power being supplied by the user grasping a hand rim 16 appropriately mounted, as at circumferentially spaced locations 18, in a clearance position externally of the wheelchair wheel 10 and enabling the grasped hand rim to be propelled in the direction of rotation providing the linear movement of the wheelchair that is desired, i.e. either forward, backward or in a turning maneuver.

While as may best be understood from FIG. 4, the wheelchair wheel tire rim 20, spokes 22 and spacers 24 at the locations 18 can advantageously be molded as a unitary article of manufacture and thus be comprised of plastic construction material, the attached hand rim 16 requires a stronger construction material, and thus typically the hand rim construction material of choice is usually steel, as depicted in FIG. 4. An unavoidable consequence of using a steel wheelchair hand rim 16 is an uncomfortable feeling to the user's hand or finger grasp about the hand rim 16 that is cold-to-the-touch.

That is, and as is demonstrated by the heat transfer diagram of FIG. 5, normal body temperature is 98.6 degrees F. and a comfortable room temperature is 72 degrees resulting in heat loss, at a steady rate, of approximately 400 BTU/hr. of body temperature to room temperature, and a stabilized hand temperature at level T1, believed to probably be 90 degrees F. When, however, hand grasp contact is made with a steel hand rim, the thermal conductivity of steel being approximately 2000 times greater than that of air, there is a drastic drop in heat loss or transfer, as depicted by the arrow 26, of the hand grip temperature 90 degrees F to the room temperature 72 degrees, which over a time period 28 stabilizes at the lower temperature level T2 and at which lower temperature, the feeling of the steel hand rim to the user's finger grasp is one that is cold-to-the-touch.

In contrast, when the within inventive external covering 30 is assembled along the hand rim 16, due to its chemical constituency selected to be effective to prevent significant heat loss and, of course, its interposed position between the hand rim 16 and the grasp of the user applied about the hand rim 16, the 90 degrees F. hand temperature is maintained, and stabilized in a short duration of time 32 at just slightly below the temperature level T1, as depicted by the dash reference line 34. At temperature T1 the hand grasp will have a feeling at its surface-to-surface contact with the covering 30 that is warm-to-the-touch, as reported in practice using the hand rim and covering assembly 16, 30. Stated otherwise, in room temperature conditions the user's hand temperature is typically reported to be comfortable and not adversely effected by the nominal heat transfer characteristics of the ambient air, and thus the chemical and physical constituency of the covering 30, as best illustrated in the cross sectional showing of FIG. 2A, having a significant number of air and/or gas bubbles, individually and collectively designated 36, has essentially the same nominal heat transfer characteristics of the ambient air, thus contributing to a user's hand temperature that is reported to be comfortable i.e. warm-to-the-touch.

Referring to FIGS. 1 and 2A, it will be understood that the covering, generally designated 30, is fabricated as a tubular configuration 38 that is slit longitudinally, as at 40, and has an adhesive coating 42 applied to opposing confronting edges 44 bounding the slit 40, each covered by a release strip 46 preparatory to removal and use of the adhesive 42 to complete assembly of the covering 30 about the hand rim 16. That is, after the steel rim 16 is attached by a screw 48 to wheelchair wheel 10, the tubular covering 16 cut to the length matching the circumference of the wheel 10 is opened along the slit 40, the release strips 46 removed, the covering 30 placed in encircling relation about the hand rim 16, and the exposed adhesive edges 44 then closed upon each other to complete the assembly 16, 30. Openings, as exemplified by opening 50 in FIG. 20, are circumferentially spaced along the tubular covering to align with the spacers 24.

In addition to a first embodiment of FIG. 2A, a second, almost identical embodiment of the covering 30 is illustrated in FIG. 2B, wherein a thin gauge external brightly colored decorative plastic cover 52 and a friction grip internal lining 54 is applied, adhesively or in other appropriate manner, on opposite sides of the covering 30. Still another, or third embodiment of the covering 30 is illustrated in FIGS. 2C and 2D, wherein the exterior surface of the covering 30 is provided with finger grip notches 58. It has been observed in practice that the color of the plastic cover 52, or in lieu thereof a bright color in the covering 30 per se, improves the patient's visual perception of which portion of the wheelchair should be grasped during propulsion, and is important to patients suffering from a cerebrovascular accident, or who are cognitively impaired, and traumatic brain injured.

A covering 30 that in practice has provided the warm-to-the-touch utility of the present invention is an expanded, closed cell, polyolef in the chemical family of a mixture of olefin/ester copolymer and petroleum derived hydrocarbons, commercially available from IMCOA of Haltom City, Tex. sold for use as heat insulation about pipes and like conduits of hot fluid or gas, to prevent heat loss from the flowing hot fluid or gas to the ambient, but not disclosed as having any utility related to external contact therewith as might suggest utility as a wheelchair hand rim cover.

While the improvements for a wheelchair wheel hand rim herein shown and disclosed in detail are fully capable of attaining the objects and providing the advantages hereinbefore stated, it is to be understood that they are merely illustrative of the presently preferred embodiments of the invention, and that no limitations are intended to the detail of construction or design herein shown other than as defined in the appended claims.

What is claimed is:

1. Improvements for a wheelchair wheel with a wheel-rotating rim of a type constructed of metal characterized by a cold-to-the-touch feeling in the finger grasp of a user applied to the wheel-rotating rim incident to urging the wheelchair in movement, said wheelchair rim improvements comprising a material disposed in covering relation over said rim selected to have a chemical constituency effective to prevent heat loss from the fingers of said finger grasp, whereby the feeling of the rim to the user is a more comfortable warm-to-the-touch.

2. A wheelchair wheel as claimed in claim 1 wherein the selected material disposed in covering relation over the rim is an expanded, closed cell, polyolefin in the chemical family of a mixture of olefin/ester copolymer and petroleum derived hydrocarbons.
